(19) United States
(12) Patent Application Publication
(10) Pub. No.: US 2018/0304271 A1
(43) Pub. Date: Oct. 25, 2018

(54) ON-THE-FLY SPEED VARIATION OF DOUBLE ROLL CRUSHERS FOR OIL SANDS CRUSHING

(71) Applicant: thyssenkrupp Industrial Solutions (Canada) Inc., Calgary (CA)

(72) Inventors: Dumitru BOJINESCU, Calgary (CA); Zoran IVOSEVIC, Calgary (CA)

(21) Appl. No.: 15/959,702

(22) Filed: Apr. 23, 2018

Related U.S. Application Data
(60) Provisional application No. 62/488,166, filed on Apr. 21, 2017.

(51) Int. Cl. B02C 4/42; B02C 4/02; B02C 4/28

(52) U.S. Cl. CPC B02C 4/42; B02C 4/286; B02C 4/02

(57) ABSTRACT

A double roll crusher is provided for mined oil sands feed, even in the winter season. Each roll has a driveline driven by a high efficiency motor controlled by a variable frequency drive (VFD). Through removal of the prior, yet ubiquitous fluid coupling and related failure-prone components, a shorter, streamlined, lower inertia driveline results. The VFDs and a system controller adapt to the processing of difficult oil sand feed, anticipating high current events, adjusting roll speed on-the-fly, adjusting feeder rate or both to minimizing the high cost of process interruptions. Maximum startup torque and on-the-fly modification of roll and feeder speeds is provided to manage feed, environment and process variations and in instances of a stall, immediate recovery therefrom for reduced downtime, reduced wear and increased efficiency.

### CROSS-REFERENCE TO RELATED APPLICATIONS

This application claims the benefit of U.S. Pat. No. 62/488,166, filed Apr. 21, 2017, the entirety of which is incorporated herein by reference.

### BACKGROUND

Roll crushers are known for size reduction in the mineral processing industry, useful in the processing of medium-hard, sticky and soft materials including oil sands. The oil portion of oil sand is a heavy oil known as bitumen. Double roll crushers use compression to size material therethrough and are useful when the feed material is not necessarily friable.

In 1992, Applicant supplied the world's first double roll crusher for in-pit size reduction at the Syncrude site in Northern Alberta, Canada for crushing and size reduction of oil sand. Environmental conditions are difficult including extreme temperature ranges from −50° C. to +36° C. Furthermore, oil sand is highly abrasive, soft and sticky in warm seasons, exhibits plastic behavior during the winter months. The oil sand material can also be intermixed with bands or pockets of clay, sandstone, silt stone, ironstone and boulders. By 2000, Applicant had supplied the Syncrude site with a 11,000 tph capacity roll crusher. Further installations have been made more recently for use in additional oil sands mining scenarios.

As shown in FIG. 1A, one form of Applicant's prior art 5,500 tph double roll crusher is illustrated.

In the literature, some double roll crushers are often also identified as sizers. Sizers are characterized as crushers in which each double roll is smaller in diameter and which may also be longer than that of crushers.

Center-type double roll crushers implement a pair of parallel and closely spaced rolls, forming a nip or gap therebetween. Each roll is formed with teeth that extend radially, the teeth of one roll being laterally offset from the teeth of the opposing roll so as to mesh therewith and maximize size reduction. Material is drawn into the gap between the rolls by the roll's rotating motion and a friction angle formed between the rolls and the particle, called the nip angle. The two rolls force the material between their rotating surface into the converging gap area, compressing and fracturing the material into smaller particles. The rolls are typically driven by a gearbox, connected to one or more motors. As shown in FIG. 1A, generally oil sand material is delivered via hopper and an apron feeder. Poor choices regarding material considerations, feeder and rolls configurations, and rolls rotational parameters can also exacerbate wear and maintenance at the rolls.

Applicants note that, to date, large double roll crushers in the industry, including Applicant's own technology, have been limited to direct drive-equipped drivelines at constant speed units, with gear box speed reduction for operation at a constant speed selected from a range of about 40 to 60 rpm. While it is known to design the operating speed of the rolls for different operating scenarios and accommodate different capacities, this procedure requires a plant shutdown such as to change a gear box, other supporting equipment modification and conduct a process restart.

Further, the components needed to drive the large rotating equipment under such loading are significant in number, size and cost. Such components can include: a motor, a flex coupling, a fluid coupling, a torque limit coupling, all of which form a driveline to connect to a gear box at the rolls. The footprint for such equipment is very large and the cost of the supporting structure, for each of the two drivelines for the two rolls, and reactive loading on same is also significant.

The variability encountered in the oil sand feed, both behavior and content, often triggers a stall, the rolls shutting down for correction of the operational conditions. Equipment shutdowns are typically automated to avoid uncontrolled equipment failure and minimize risk to maintenance personnel. The shutdown is costly in terms of lost production, a restart often measured in hours, with surge capacity only available up to one hour. Lost production is a significant cost, at 5000 bitumen bbl/hr at $25/bbl being $125,000 per hour. At 10,000 tonnes of oil sand per hour, (tph) interruptions have been documented at over $5,000,000 per year. Operational delays due to a stall include, in some occasions, refilling the ejected oil reservoir of a failed fluid coupling, and many occasions, clearing the material that caused the stall and high inertia restart attempts.

Under re-starting conditions under full load, such as after a stall with oil sand material in the rolls, even to clear the rolls by reverse rotation, the fluid coupling is subjected to such high energy during the startup phase that the motor and fluid coupling cannot come up to speed fast enough along the motor's torque curves, and at sustained high torque at the fluid coupling causes overheating of the oil and the coupling can fail again with a fusible plug release and ejection of the fluid.

Conventional AC induction motors have a breakdown torque (BDT) of 175-300% of rated load torque and generally a BDT of over 200%. Where motor BDT is identified as a limit to starting and torque under upset conditions, improved motors, with higher breakdown torque have been introduced, however they are rendered impotent as the fluid couplings become the limiting factor. At crushing capacities of 10,000 tph larger fluid couplings are not commercially available and use of variable fill fluid couplings, requiring oil circulation and cooling management, introduces a whole host of new maintenance and cost issues including oil coolers, pumps, control systems.

As introduced above, disadvantages have been noted with the known fluid coupling equipped double roll crushing operations of oil sand including: stalling and restarting, potentially damaging high speed inertia, under-performance in processing capacity, and a need to adjust to seasonal variations in material handling and crushing characteristics.

Oil sand is a difficult material, particularly due to the material properties in winter, the double roll crusher drivelines currently resulting in too many unplanned shutdowns and equipment failures. Applicant has determined that significant production savings are achievable through improvement of the drive components, and operation of crushing operation. As a result, further improvements are achieved including wear considerations, energy conservation accommodations during process upsets, and coordination of the double roll crushers with peripheral equipment in the process as a whole.

### SUMMARY

As described herein, process interruptions are minimized with an associated reduction in economic losses by elimination of the ubiquitous, and relatively inexpensive, fluid coupling. Without inclusion of a fluid coupling, additional advantages become available including one or more of greater utilization of more efficient electrical motors, reduced rotating inertia-induced risk to connected equipment, and anticipatory control of the streams of oil sand material for reduced downtime, reduced wear and increased efficiency.

Oil sand is a difficult material in many respects and affected by changes in the mined ore, moisture content, temperatures variations including seasonal and daily variations. In one regulatory application of an oil sand project, the operator noted a 2.5 times higher reject rate of mined oil sand ore in winter operations over that conducted in summer months.

Crushing is most efficient when applied to non-compressible friable material which fractures readily, unlike the compressible variable plastic oil sand material. In summer conditions the bitumen between the sand grains of mined oil sand binds the mass together in a viscous mass like softened asphalt. In winter conditions, the mass is similar to concrete but tougher, the bitumen component giving the mass a plastic behavior, that does not readily shatter when compressed. Double roll crushers, less favored in conventional mining operations, have found a home in the sizing of oil sand feed.

Solutions to the identified challenges inherent in oil sand crushing, particularly in winter operations, are provided herein and in stark contrast to the solutions noted by another supplier of double roll crushers to the oil sands industry. Recently, this other supplier was engaged to solve winter time stalling of their double roll crushers, the problems including stalling, restart inability associated restrictions on production in winter. The supplier's response was apply a fluid coupling of an apparent larger capacity than previously used heretofore, to increase in drivetrain inertia and to increase available motor torque the result of reducing peak crushing demand by about 50%.

In contradistinction, Applicant has reduced each driveline inertia by upwards of 80%, rather than the prior art approach of increasing inertia. Applicant has eliminated the fluid coupling, rather than custom design or installing a larger unit or adapting more complicated and maintenance intensive strategies.

Instead, Applicant has replaced the fluid coupling and associated components by a variable speed drive with feedback of load at the drive for double roll management and integrated control of associated equipment. Several drive options include wound-rotor motors, hydraulic or electro-hydraulic systems and variable frequency drives (VFD) coupled to AC induction motors. Wound-rotor motors are available for high-inertia loads having a long acceleration time by control of the speed, torque, and resulting heating through resister banks. Similarly hydraulic motors and VFD-equipped hydraulics, use variable fluid flow for variable driven hydraulic motor control, the flow or pressure of which is an analogue to motor current. In both instances, achieving the variable speed is associated with increased hardware and maintenance costs.

In an embodiment implementing a VFD coupled to an electrical motor, albeit at a capital cost somewhat more than that of fluid couplings, savings are found in reduced number of components and reduced rotating inertia, higher torque when required, control of motor speed under changing process conditions and markedly reduced downtime.

Coupled with the VFD is a high efficiency motor, controlled by the VFD, for delivery of sustained and high break down torque capability, all of which is available for overcoming startup and upset conditions associated with the difficult characteristics of mined oil sand in winter. In additional to maximizing startup torque without failure, further use of a VFD and variable speed operation enables to adaptation to process conditions on-the-fly.

On-the-fly operation includes changing rotational speeds to change performance without requiring a shutdown or reconfiguration of either the mechanical components of the rolls, or adjustment of the feed stream of material thereto. Further, on-the-fly also permits optimization of the mechanical wear versus processing capacity of the equipment. Mean time between failure (MTBF) can be improved, and the periods between scheduled maintenance increased, which are significant factors in the overall performance and reliability of the process streams from the mine to the bitumen froth treatment lines. Efficiency and energy cost can be optimized through power management when full load is not warranted.

Elimination of most of the conventional mechanical components in the drivelines for the double rolls results in improvements including capital savings in the components themselves, in reduced structure required for support of same, and operational benefits. Mechanically, the length of the driveline is significantly reduced. For a nominal 12,000 tonnes/h (tph) of oil sand, the reduction in length of the driveline can be reduced at least in the order of about ⅓, from a nominal 6 meter to about 4 meters, reducing the structure, the inertia and the reactive moment applied between the rolls and the respective motors.

As a result, a shorter, streamlined driveline results with fewer components and the elimination of the component that has repeatedly failed under theses onerous conditions. Further advantages include higher breakdown torque, reduced maintenance cost and increased equipment availability due to fewer parts requiring less maintenance and service (longer MTBF). The use of a VFD or equivalent also enables on-the-fly speed variation and soft start, even under full load or plugged conditions, up to the motor breakdown torque.

Overall the crushing and oil sand feed system applies strategies for operation in recognition of the common challenge of overcoming oil sand feed difficulties including environment, off-specification or gradual variations in particle distribution.

Further, operations in the process line can be improved with predictive operations of the crusher rolls and feeder in advance through monitoring and response to oil sand feed material variation or rate and process interruptions.

In one aspect, a double roll crusher is provided for mined oil sands feed of variable quality comprising contra-rotating double rolls in a parallel arrangement for forming a nip therebetween for receiving the oil sand feed, each roll having a driveline. Each driveline comprises a gearbox having input and output shafts, the output shafting being driveably connected to its respective the roll, an electric motor having a motor rotor driveably connected to the gearbox's input shaft. The driveline further comprises a torque limiting coupling situate between the motor rotor and the gear box input shaft, the driveline having a rotating inertia. A variable frequency drive (VFD) having a variable frequency electrical output is coupled to the motor rotor, a torque limiting coupling between the motor rotor and the gear box input shaft, the driveline having a rotating inertia, wherein each VFD varies frequency and voltage to its respective motor for delivery of up to full load torque to the driveline and to vary the speed of the rolls commensurate with the quality of the oil sand feed.

In embodiments, the VFD determines a motor current and reduces the speed of the rolls as the motor current falls below a design motor current. Further, the wherein the oil sand feed comprises oil sand, and an oversize component, together having a feed quality, for a design throughout, the VFD determines the motor current and reduces the speed of the rolls as the motor current rises above a design motor current and increasing the speed of the rolls as the motor current falls below the design motor current.

In another aspect, an oil sand crushing system comprises the above oil sand crusher further comprises a hopper, a feeder below the hopper and having a discharge positioned above the nip, a feeder controller for varying the feed rate of oil sand feed from the feeder; and a system controller connected to the double rolls VFDs and the feeder controller for adjusting feed rate from the feeder inverse proportional to the motor current at the VFD.

In embodiments, upon a stall in a forward crushing rotation, the feed rate is reduced to zero, and the VFDs are activated to reverse rotation of the motor rotor and vary frequency and voltage for delivery of full load torque to the rolls to clear the oil sand feed from the stalled rolls.

In another aspect a method of controlling a double roll crusher for crushing mined oil sands feed having variable quality at a design throughput comprises receiving oil sand feed at the nip of contra-rotating double rolls, each roll having a driveline including an electric motor and a gear box connected to the respective roll; and varying the voltage and frequency of the respective motor for delivery of up to full load torque to the driveline and to vary the speed of the rolls commensurate with the quality of the oil sand feed.

In embodiments, for a given design throughput, one determines a motor current that is falling below a design motor current, and reducing the speed of the rolls, while maintaining a design throughput of oil sand feed through the rolls. In embodiments in which the oil sand feed comprises oil sand, and an oversize component, together having a feed quality that varies over time, one determines a motor current for the current feed quality; reduces the speed of the rolls as the motor current rises above a design motor current; and increases the speed of the rolls as the motor current falls below the design motor current. Further, control of said system can further comprise determining a motor current; controlling the rate of oil sand feed from a feeder and discharging into the rolls; and adjusting feed rate discharging from the feeder inverse proportional to the motor current.

### BRIEF DESCRIPTION OF THE DRAWINGS

FIG. 1A is an illustration of a typical installation of one of Applicant's conventional hopper, apron feeder and double roll crusher;

FIGS. 1B and 1C are side and plan views respectively of a schematic of the components of a conventional direct drive, fluid coupling equipped driveline for a double roll crusher;

FIG. 2 is repeated presentation of the side view of the conventional direct drive according to FIG. 1B, repeated herein for same-sheet comparison with the current embodiments described herein;

FIG. 3 is a side view of a schematic of a second embodiment through removal of the fluid coupling and implementation of a variable frequency drive implementation of the variable speed double roll crusher;

FIG. 4 is a schematic side view of a hopper, apron feed, double roll crusher and related process controls in one embodiment;

FIGS. 5A through 9B are graphs illustrating the qualitative relationships between some of the operational factors leading to controlled variation in the instantaneous rotational speed of the rolls of the current embodiments, more particularly:

FIG. 5A is a graph of an example torque curve over time for the prior art driveline of FIGS. 1B and 2;

FIG. 5B is a graph of an example torque curve over time for the driveline of the current embodiment according to FIG. 3;

FIG. 6A is a graph of an example torque curve over time for the prior art driveline of FIGS. 1B and 2 in a stall recovery operation;

FIG. 6B is a graph of an example torque curve over time for the driveline of the current embodiment according to FIG. 3;

FIGS. 7A through 7C, illustrate the relationship and control of the apron feeder and rolls speed over time, namely FIG. 7A is a graph of the oil sand crushing work demand on an example double roll crusher over time;

FIG. 7B is a graph of an example oil sand throughput and rolls rpm over time;

FIG. 7C is a graph of the apron feeder output over time;

FIG. 8A is a graph of motor current over time for an oil sand feed varying from the nominal or design quality to some improved quality and back again;

FIG. 8B is a graph of crusher rolls speed to lessen roll wear as the feed improves;

FIG. 9A is a graph of motor current over time for an oil sand feed varying from difficult to stall and through a restart again;

FIG. 9B is a graph of the apron feeder feed rate over time adjusted in response to the motor current.

### DESCRIPTION

Oil sand deposits of Alberta, Canada comprise bitumen oil in sand. Exploitation of the oil sand involves a sequence of mining, bitumen extraction and bitumen upgrading operations. The oil sand formations are mined to remove in-situ bitumen bearing ore from the formation which is then processed to separate the oil portion from the sand, water and mineral materials. Once separated, the bitumen is then further processed into intermediate or finished products such as synthetic crude oil, fuels and the like.

For the extraction of bitumen from ore, the size of the mined oil sand must first be normalized. The as-mined oil sand is passed through a double roll crusher prior to a slurrying process to reduce feed size below about 600 mm. The mined oil sand feed contains a variety of constituents, the bulk of which is oil sand, and includes oversize such as shale and other rock inclusions. When frozen, the oil sand feed can also behave like oversized lumps. The concentration of oil sand lumps is greater in winter, when some of the oil sand reports in the form of partially frozen chunks that behave as a plastic material. Between slurry preparation and the crusher, the crushed oil sand is directed to a surge bin to aid in short term process interruption. The surge bin typically has 20 minutes to 1 hour of storage. Whether the slurry is prepared for hydrotransport over some distance, or more directly, for bitumen extraction, the comminuted ore is mixing with water and solvent for separation of the bitumen from the oil sands.

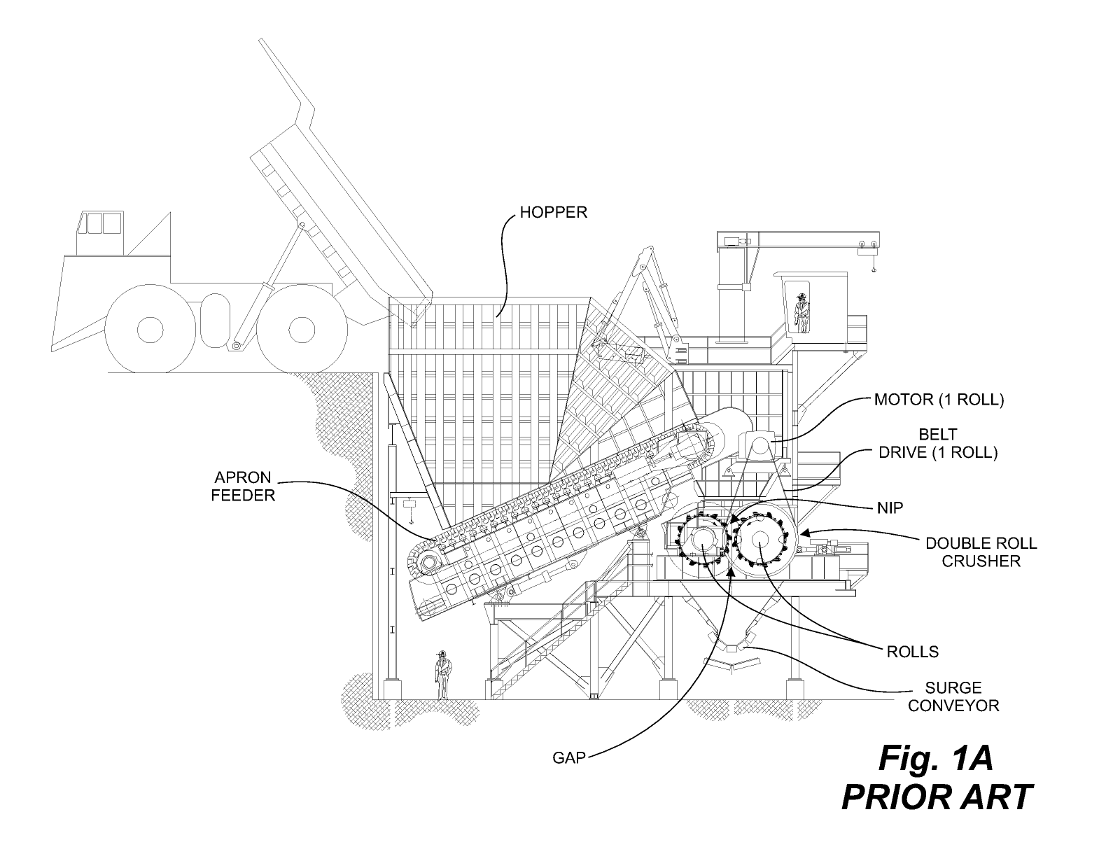

With reference to FIG. 1A, an elevation a conventional double roll crusher is shown having a feed hopper with an apron feeder therebelow and a double roll crusher. The crusher rolls are shown through partially transparent crusher housing end walls. The apron feeder is located at the bottom of the hopper and is inclined upwardly to an exit of the hopper for conveying oil sand feed out of the hopper at some design rate for discharge into the nip between the two rolls. Sized oil sand feed is directed to a surge conveyor for transport to surge bins (not shown).

Large rocks, other undesirable oversized solids and frozen oil sand, that are not previously removed at the mine, are crushed. Double roll crushers crush the largest portions of the oil sand feed using compression, with the two opposing and contra-rotating rolls rotating about their respective shafts, a lump entering the nip and being compressed towards the converging gap between the rolls. The smallest gap between the opposing rolls is set to the size of product desired, with the largest feed particles being typically 4 to 6 times the smallest gap width. The lumps and particles are drawn into the gap between the rolls by their rotating motion, a friction angle formed between the rolls and the particle and aided by laterally meshing teeth. The two rolls compress and force the feed stream of particles between their rotating surfaces into the ever smaller gap area, fracturing larger particles and producing the smaller, sized product at about the dimensions of the gap.

The double rolls are driven individually or jointly, shown here as comprising individual drivelines for each roll, driven from opposing ends of the crusher rolls. For oil sand operations, the rotational speed of the rolls is in range of 40 to 60 rpm.

### Prior Fluid Coupling Systems

With reference to side and plan views of FIGS. 1B and 1C, a prior art driveline 10 for one roll is shown for one of Applicant's prior direct-drive, double roll crusher 12. Each roll 40,42 includes its own driveline 10, accessed from opposing ends of the crusher 12, for structure and access considerations.

Each prior driveline 10 typically comprises a motor 14 having a rotor 15, a fluid coupling 16, a flexible coupling 17, a steady bearing 18, a torque limiter 20, and a driveshaft 22, all of which is coupled to a gear box 24. The steady bearing 18 and flexible coupling 17 has been located between the fluid coupling 16 and the torque limiter 20 to ensure precise equipment alignment for optimal design operation of the coupled components. The gear box 24, typically a ratio of 20:1, has a high speed input shaft 25 and a low speed output shaft 26. The motor has a speed range from 0 to 1200 rpm for a maximum output speed at the rolls of 60 rpm. The output shaft 26 is driveably connected to its respective roll 40 or 42. Each of the two drivelines 10,10 terminates at its respective gearbox 24 for driving each of the two crushing rolls 40,42. One end of each roll 40,42 is driveably connected at its gear box 24 and an opposing end is fit with a flywheel 34 for inertial stability.

As described above, the fluid coupling 16 has been used to date as a soft start coupling, providing hydraulic slip for enabling the speed of the motor 14 to ramp up to full speed rotation while the rolls 40,42 take a longer duration to speed up. The fluid coupling 16 receives input from the motor's rotor 15 for accelerating the downstream rotating masses of the driveshaft 22, gear box 24 and respective roll 40 and flywheel 34.

Even when the rolls 40,42 are under non-load conditions, the energy transfer, between the high speed input from the motor 14 and ramping up of the slower speed output at the gear box 24, is significant due in part to the large inertia of the respective rolls 40,42.

In operation of this prior arrangement, if the rolls 40,42 stop rotation or stall, such as due to a jam or heavy material load, or on initial startup, the energy needed to accelerate the rolls is significant and can quickly result in overheating of the fluid coupling 16. Further complicating the speed up, and characteristic of three-phase AC induction motors, the torque-speed curve includes a low pull-up torque and can include a torque depression at intermediate motor speed. As the motor rotor 15 speeds up, the torque is lower than the minimum breakdown torque which can result in insufficient torque to actually permit the motor 14 to reach full speed. Thus, when the load exceeds the pull-up torque, the motor 14 struggles to accelerate at an ineffective and continued sub-normal rotation, with heat being generated at the fluid coupling 16, without ever reaching sufficient pull-out torque for full speed operation before shutdown occurs.

Overheating can trigger a shutdown including, failure of the fluid coupling 16, melting of a thermal fusible plug. Preferably a systems interlock shuts the fluid coupling down before equipment failure; regardless, the process is interrupted. Further, operator adjustments to tune the fluid coupling, to increase fluid coupling fluid levels for faster starts or to decrease fluid levels for more gradual starts at greater overheating risk, is an uncertain art and has resulted in failures in the fluid coupler and in other components.

The fluid coupling 16 has a limited duration at which it can accept differential rotation at maximum motor torque before the fluid heat leads to failure. In simple terms, the fluid coupling 16 comprises an input impeller that is connected to the motor's rotor and an output impeller ultimately connected to the rolls 40,42 trough gear box 24 . The impellers are housed in a shell casing that contains a fixed volume of operating fluid. The operating fluid circulates in a continuous vortex between the input impeller and the output impeller. Torque transmitted by the fluid coupling 16 is proportional to the difference in moment of the fluid as it enters and leaves each impeller. A speed difference between impellers, or slip, results from friction and shock losses. For a given frame size, the torque versus speed slip characteristics are altered by changing the fluid fill. Excessive slip in the fluid coupling 16, monitored for both time duration (seconds) and/or intensity (percentage of slip), occurs in heavy crushing instances when the torque demand processing oil sands exceeds the fluid coupling's capability to deliver the maximum motor torque to the drive system. Slip can be equated to fluid coupling and heat generation, output from speed encoders being used to anticipate fluid coupling failure and automatic shutdown. Extensive monitoring and control system programming are exercised to maintain the operational throughput as demanded by the customer.

Additionally, high speed inertia exercised by the inner impeller of the fluid coupling 16 and the other components currently in the long drivetrain 10 generates nuisance trips of the torque limiter 20 adding to the significant stoppage time already recorded to overheating of the fluid coupling 16. At a gear box of 20:1, a mere ¼ revolution effective for crushing is equivalent to 5 revolutions of the output impeller fluid coupling. The torque limiter 20 is located therebetween and is triggered at a about mere 1/10 of the rotation.

Again, for a 2000 HP driveline, the largest commercially available fluid coupling a Voith Turbo coupling T1150 (Voith Turbo GmBH & Co, Germany), and at usual loading, can only accept about 10 seconds of hydraulic slip before it fails. Failure is characterized by the release of fusible plugs and a hazardous discharge of the oil fill. Instrumentation has been employed to attempt to shutdown the driveline before the fluid coupling equipment safeties are triggered. In any event the double roll crusher 12 is down and the processed load must be cleared before returning to normal operation. While a fluid coupling is in operation, and rotating, excess heat can be shed in minutes. However, once failed and stopped, the cooldown of the fluid coupling 16 before restart is measured in hours.

Further, during operation, should there be a sudden slowdown or jam at the rolls, the reactive inertial loading on the slowing gear box 24 to decelerate the driveline 10 is significant. For example, the work done in a double roll crusher 12 occurs in about ¼ revolution of the rolls as a lump enters the top of the nip and is compressed through the gap. For simplicity, at a rotation speed of 60 rpm, this ¼ revolution occurs in 0.25 s. Should a jam occur, this nearly instantaneous deceleration results in very high loads. The rotating inertia of each driveline component is significant, for example the mass of the rotor 14 of the 2000 HP motor 14 being in the order of 3000 kg, the flexible coupling 17 being 600 kg and the fluid coupling 16 being 1500 kg. The entire 5000 kg of rotating mass of the driveline is arrested at the gear box 24 and, but for the inclusion of a torque limiter 20, the expensive gear box would be damaged.

In the large mining scale of oil sands crushing, the cost associated with fluid coupling-related failures numbers have been noted in the area of over $5 million per year in equivalent downtime. In attempting to solve fluid coupling-related failures Applicant has noted that some of the largest fluid turbo-couplings commercially available are rated to a maximum power range of 3000 HP and will transfer torque reliably up to 280% FLT due to design and fabrication limitations. To meet the demand of current operational specifications for double roll crushing, high efficiency AC induction motors are being implemented capable of sustained 350% FLT (7000 HP motor equivalent at 100% FLT). While the customer pays a premium for high performance motors, the perceived benefit is obviated due to the fluid coupling limitations to receive such high staring torques.

What is required is means to better control the crushing process to avoid the extremes of operation and risks built into the fluid coupling paradigm.

### Current Embodiment

Accordingly, Applicant has provided at least a replacement driveline 10 that eliminates the fluid coupling 16 and downtime associated therewith and further gains in improved operability, energy savings and reduced capital expense for support structure.

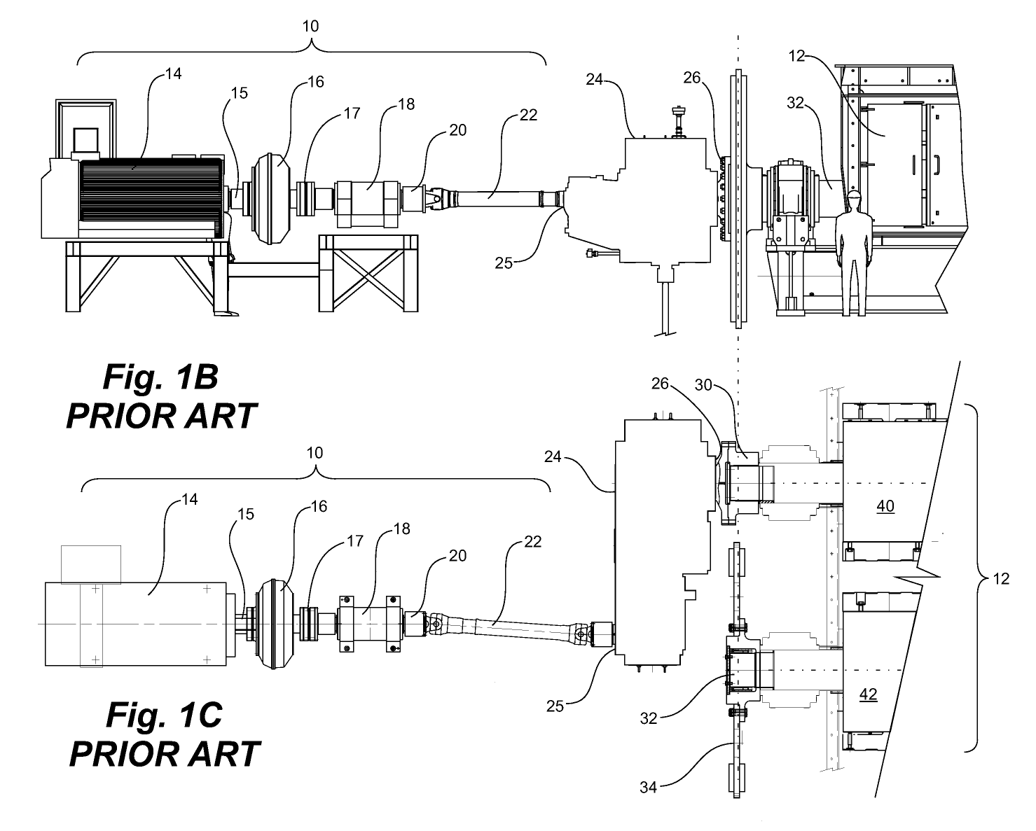

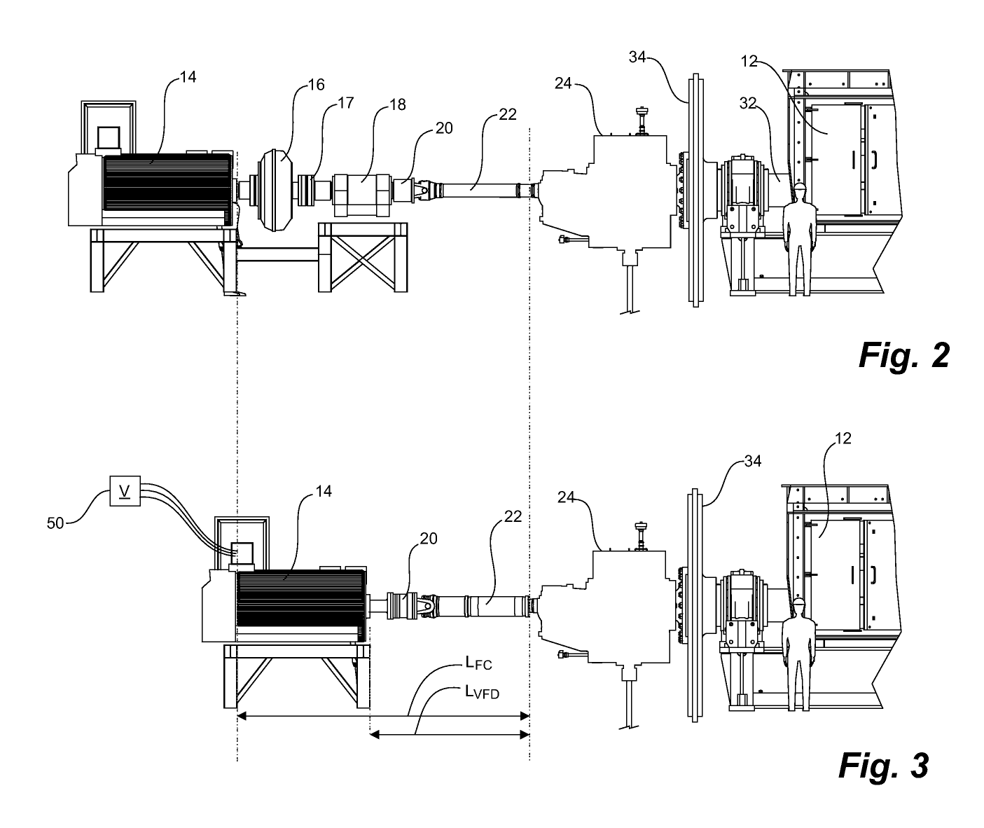

Accordingly, turning to the embodiment of FIG. 3, and comparing the driveline of the prior art of FIG. 2 and the current embodiment of FIG. 3, the fluid coupling 16, the flexible coupling and steady bearing 18 can be eliminated. The length LFC of the prior driveline, compared to the length LVFD of the VFD equipped driveline 10 has been reduced about half. Soft start and process control is now provided by the Variable Frequency Drive (VFD).

In a first embodiment, a VFD 50 is electrically coupled to the motor 14, for elimination of the conventional fluid coupling. Now applicant can apply larger torque than has been previously applied. Accordingly, a high efficiency AC induction motor 14 is implemented capable of full load torque (FLT) in excess of the conventional 280% with examples herein capable of sustained 350% FLT. Accordingly, as shown, the driveline 10 can be reduced at least by the prior fluid coupling 16, flexible coupling 17, and connecting flanges, steady bearings 18 and the like.

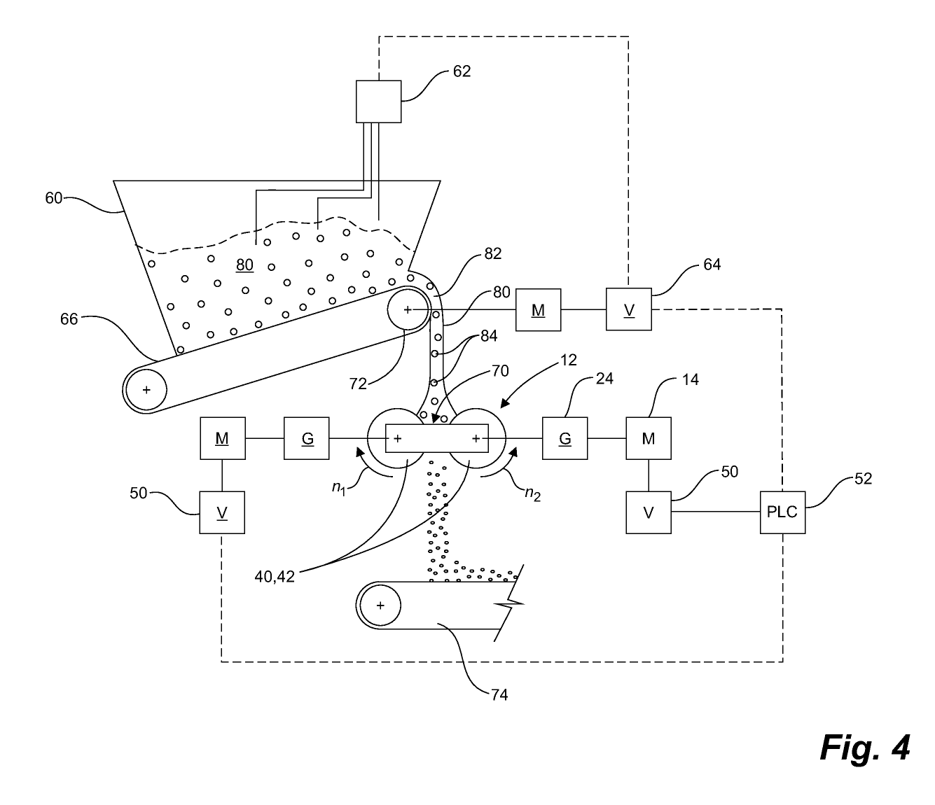

Turning to the schematic of FIG. 4, a system controller (PLC) 52 is coupled to the double roll crusher VFDs 50,50. The VFD provides a determination of the speed of the rotor 15, however encoder feedback provides improved speed regulation. Other variables that can be determined for the system, and available from the VFDs include voltage, frequency, output current torque and power.

Hopper 60 is fit with one or more hopper level sensors 62 connected to an apron speed controller 64 coupled to an apron feeder 66 under the hopper 60. The apron feeder 66 provides a live bottom for engaging the entirely of the oil sand feed material 80 in the hopper 60. A nip 70, of the opposing and parallel rolls 40,42, of the double roll crusher 12, is located below a discharge end 72 of the apron feeder 66. A surge conveyor 74 is located below the crusher 12 for conveying sized oil sand to one or more surge bins.

In normal operation, oil sand feed material 80 is dumped into the hopper 60 and maintained between two operational levels to maintain process stability. As long as the feed rate and characteristics of the material 80 from the apron feeder 66 is consistent, then the speed n1,n2 of the double rolls 40,42 is maintained at a design rotational speed. For synchronous operation of the double rolls 40,42, in one embodiment, the two VFDs are in electronic communication for synchronizing each driveline 10,10 or the system controller 52 synchronizes the VFD's 50,50.

The oil sand feed material 80 comprises oil sand 82 and oversize 84, including oil sand lumps in cold weather, the quality of which varies over time at due to the aforementioned conditions.

In embodiments discussed below, should the hopper level drop below a threshold level, there could be a reduction in the rate of feed delivered to the crusher. If so, then the crusher speed can be reduced accordingly. This results in an adaptation of the crushing to a variable feed stream for efficiency of crushing and power savings.

### Startup

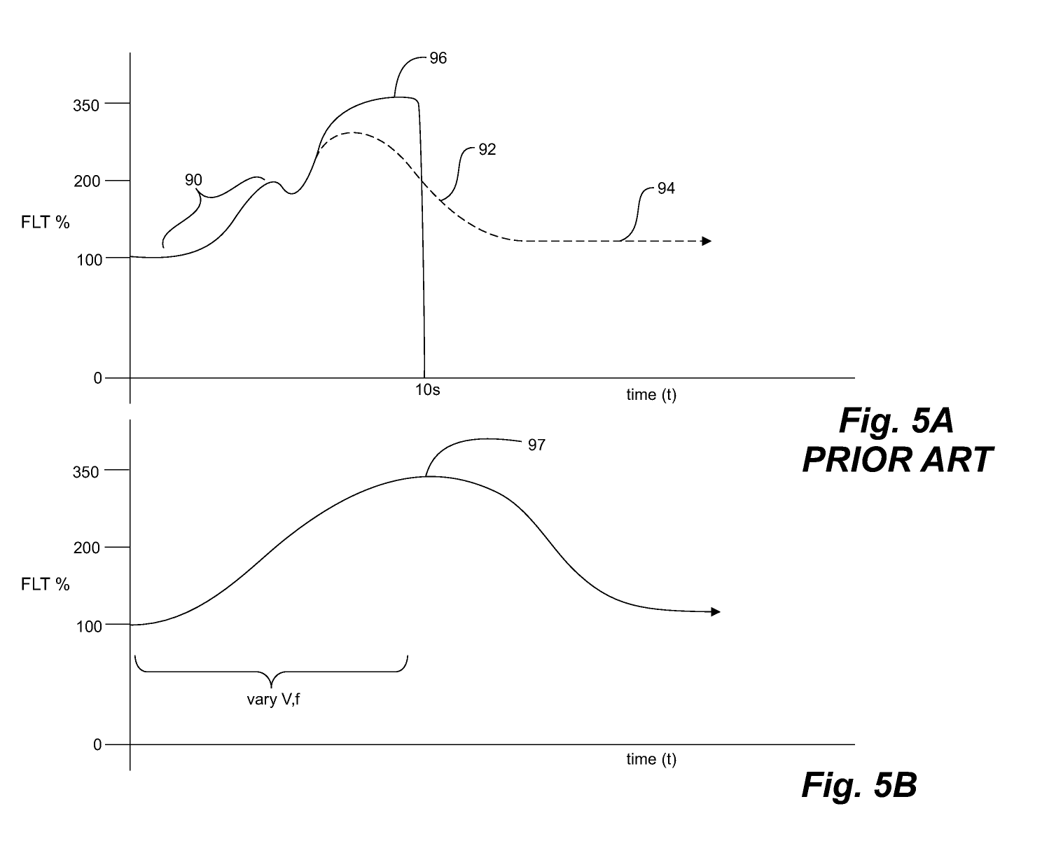

With reference to FIGS. 5A and 5B, and comparing the old fluid coupling system (FIG. 2) and the current VFD system (FIG. 3), an illustration of torque-time curves for the systems is presented. In the prior art FIG. 5A, and in view of the factors described above of fluid coupling-equipped systems, it is known to first permit the speed of the motor rotor 15 and its delivered torque to rise at 90 before fully engaging the fluid coupling. Following the dotted line 92, should the fluid coupling 16 and crusher 12 successfully come up to operational speed in less than a start-up duration of about 10 seconds (before overheating), then torque and current fall off and operations continue generally at design torque and current levels at 94.

However, as illustrative of the problems disclosed herein, as shown by the solid line 96, in cases of a prolonged startup, such as that due to difficult oil sand feed in winter, the fluid coupling 16 may not come up to speed within the setpoint duration of 10 s, despite maximum delivered full load torque (FLT) and thus an interlock or equipment failure occurs.

In contradistinction at FIG. 5B, using the present VFD 50 embodiment, Voltage (V) and frequency (f) can be varied continuously during startup for long durations, maximizing torque and progressively nursing the acceleration of the system at, or up, to maximum delivered torque at 97 as necessary. The duration of the FLT applied at maximum, can be extended without consequence other that for overriding consideration due to other system diagnostics. With the VFD 50, and e-motor 14, torque at 350% FLT can be provided even at zero rpm. Therefore, for difficult oil sand feed material, and without any compounding mechanical or other fault, full torque can be applied from zero to full speed of the crusher rolls 40,42. Operational rotational speed is achieved and continues to the full speed motoring region of the torque-speed curve, achieved for normal operations.

### Stall

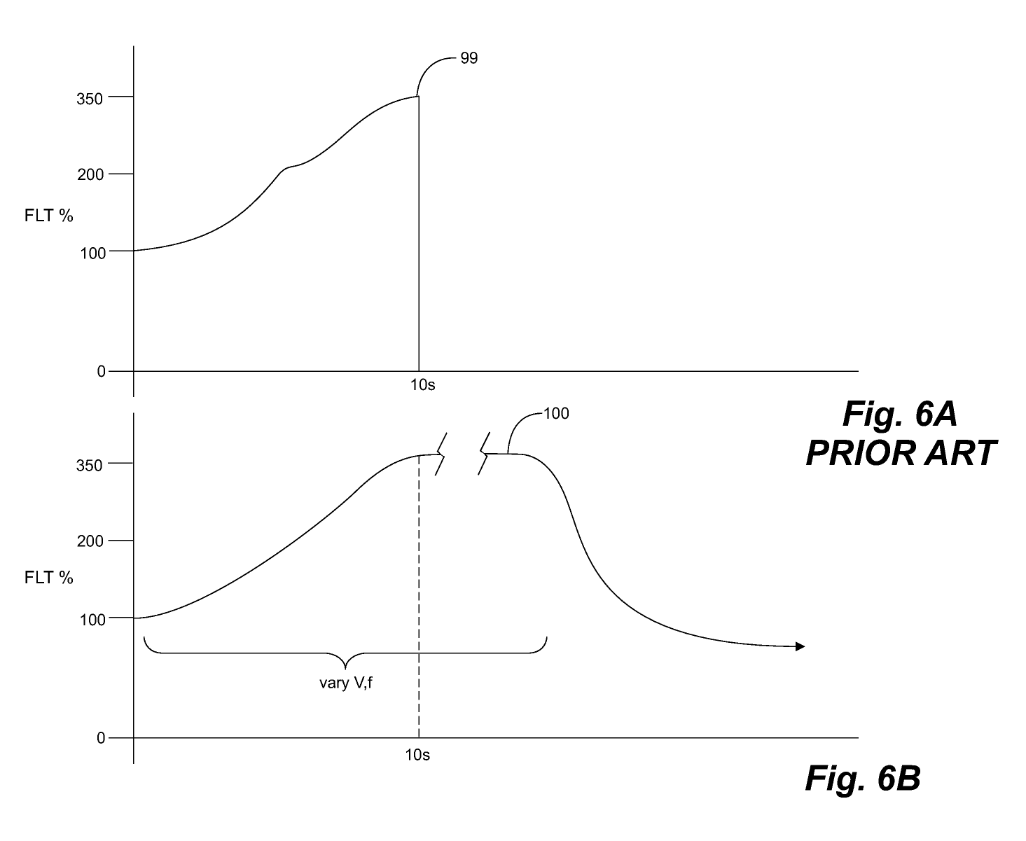

With reference to FIGS. 6A and 6B, comparing the old fluid coupling system and the current VFD system, an illustration of torque-time curves for the systems is presented for a scenario in which the double roll crusher 12 encounters a processing overload causing sudden and increase power demand over normal, including a scenario required to initiate a re-start under load. In FIG. 6A, for the prior fluid coupling-equipped systems, against, once the motor speeds up and the fluid coupling becomes engaged, the torque continues to rise to failure or triggering a shutdown interlock such as a 10 seconds.

In contradistinction, for the present embodiment of FIG. 6B, using the VFD 50, again through manipulation or V and f, maximum motor torque can be provided to assist in overcoming more than usual commissioning run-up loads. The viscous-influenced loads can require longer that normal acceleration to overcome the process upset. The VFD 50 enables up to a maximum delivered FLT for, and as long as needed, at 100 to effect full speed rotation. Further, after a stall, the rolls can initially and readily be reversed at the same FLT advantage, such as to clear a jam or the uncrushed materials, and then be returned to standard, forward rotation operation.

### On-the-Fly

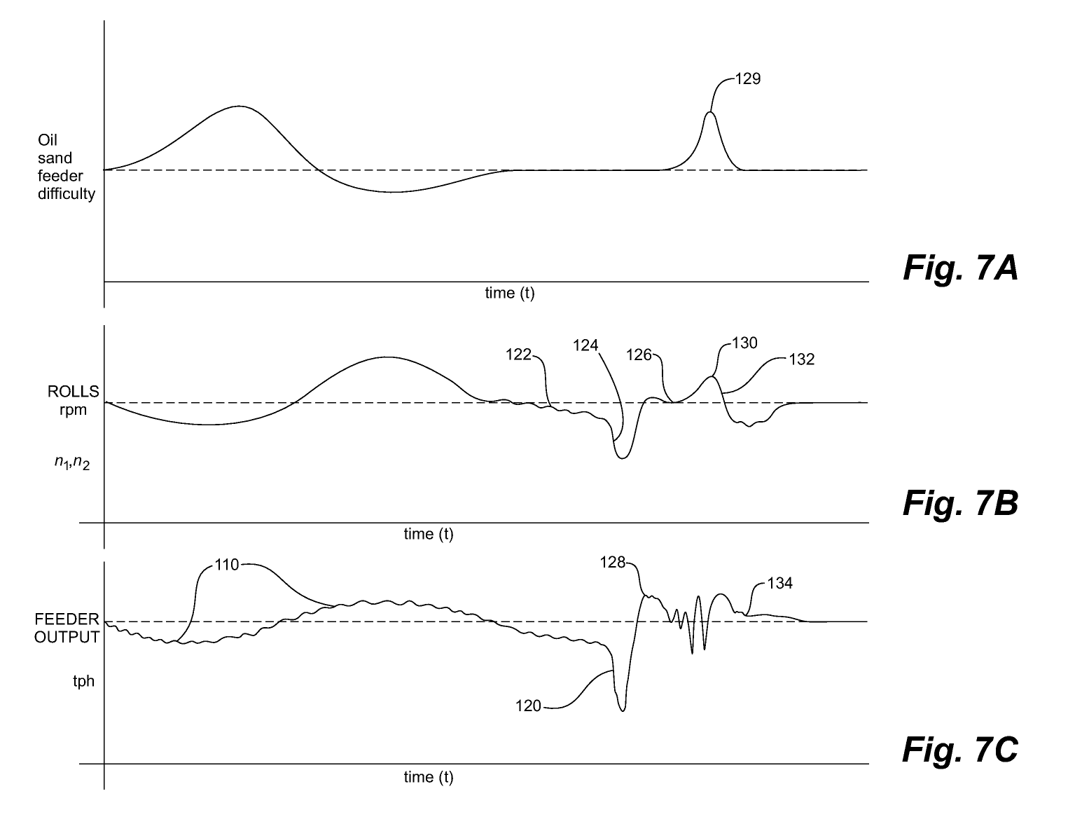

Turning to FIGS. 7A through 7C, a few of the factors related to speed control of the rolls are illustrated over time, on-the-fly, including the feeding and crushing difficulty of the oil sand feed 80. Each VFD varies frequency and voltage of its respective motors for delivery of up to full load torque to the driveline and to vary the speed of the rolls commensurate with the quality of the oil sand feed.

The process control is first described in the context of processing a fraction of oversize present in the feed, greater than or less than design parameters. When the amount of oversize in the feed is detected as increasing over design, say increasing from 20% to 30% by weight at 102, the rolls speed can be reduced at 104 to process the oversize without a significant increase in motor current A. Similarly if the amount of oversize decreases from 20% to 15% at 106, the rolls can be reduced in speed at 108, maintaining throughput yet reducing the load on the moving components. Similarly, depending on the magnitude of the variation, the rate of feeder 66 can be manipulated at 110 to balance the majority of the load on the rolls 40,42, being at about 80% or so of the oil sand portion of the feed that needs little energy to process, with a periodic increase in demand needed only for larger or more prevalent oversize.

For a given design throughput an advantage with the VFD 50 is that one can readily manipulate the speed of the rolls 40,42 to adapt to the more difficult oil sand feeds, and when the material is less abusive, one can maintain throughput with the feeder 66 while reducing rolls' speed to reduce wear on the rolls 40,42 themselves and other rotating components.

The relationship of rolls' rotational speed to oil sand feed material characteristics or processing difficulty, discussed in the preceding paragraphs in the context of oversize content, can similarly represent the relationship due to seasonal and daily temperature effects. Substituting temperature for oversize, one can see the similar relationship as temperature falls with increased crusher difficulty, typically reflected at the VFD 50 and system controller 52 as increased motor current A, with a corresponding process response at 104 to reduce rolls' speed. Feed difficulty is exacerbated by weather change, variation changes and by changes in the mine processes.

Returning to FIGS. 7A, 7B and 7C, in another illustrative scenario, as the feeder 66 experiences a physical problem at 120, such as a large boulder 88 blocking the discharge of the hopper 60, the feed rate of material 80 overall delivered to the crusher 12 will diminish at 122. As an operator diagnoses the issue, the VFD 50 can already be reducing the speed of the rolls 40,42 at 124, for energy and wear-related savings. The rolls' speed can be increased at 126 anticipatory of resolution of the feeder issue, or concurrently as the feed rate increases once again at 128. Further if the known issue is an oversize rock 84 that will suddenly release at 129 and be processed, the VFD 50 can temporarily increase the roll speed and crushing inertia at 130 before receiving the feed 80 generally and rock 84, thereafter lowering the rolls' speed at 132 as the excess inertia is consumed and then processing the balance of the upset, at 134, from the feeder 66 at a lower roll speed.

The torque limiter 20 is set at an overload torque greater than that capable by the motor. The torque limiter is provided to protect the downstream equipment, not from a ramping up of the load that is managed by the VFD, but in response to an instantaneous deceleration event. In some circumstances, the rolls receive a foreign object in the feed, such as broken pieces of equipment from the mine. In that event, the rolls and gear box stop substantially immediately while the motor rotor 15 and driveshaft are also required to also stop immediately thereafter. The inertia in the driveline, albeit reduced over the prior art, places an overload torque on the gear box, that intercepted by the torque limiter 20.

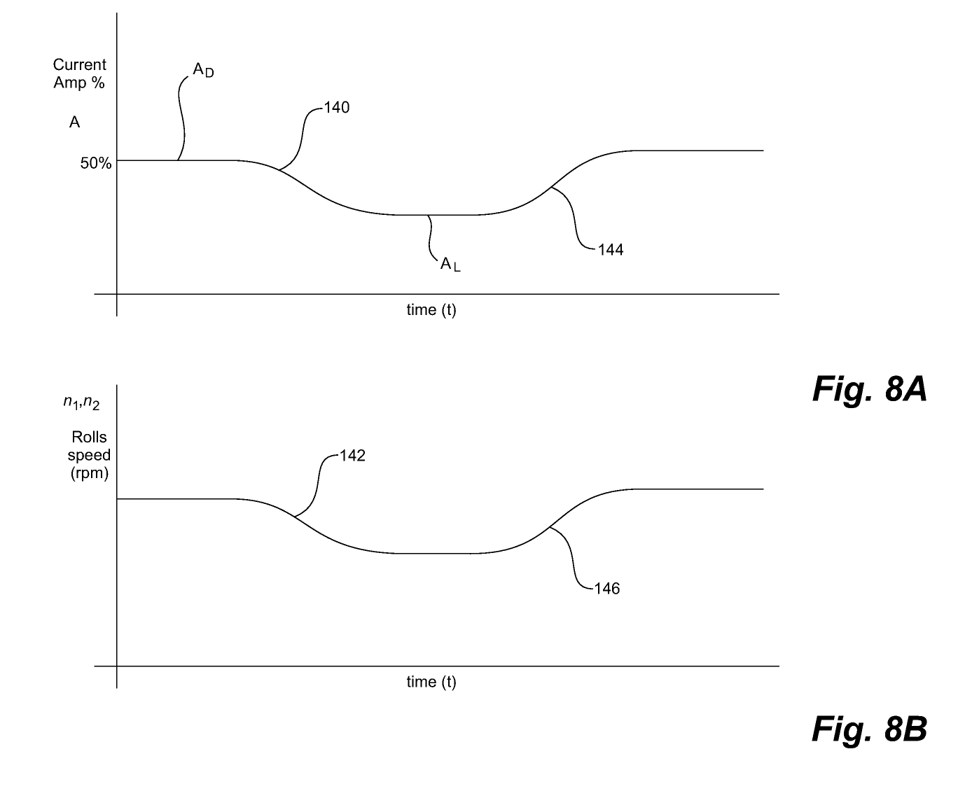

With reference to FIGS. 8A and 8B, the rolls 40,42 and feeder 66 are controlled to maintain design throughput at design conditions, yet process less difficult feed 80 at that same design throughput whilst reducing wear at the crusher 12. At normal conditions, the design motor current AD for crushing at the rolls 40,42 might present at 50% of design. The motor current A is sensed or otherwise detected to fall at inflection 140, to some lower current AL, indicating an improvement in the quality of the feed 80 such comprising more friable feed (summer, or having less oversize), the rolls' speed can be reduced at inflection 142, while continuing to maintain the rate of oil sand feed 80 at about the design throughput, albeit at a lower speed and corresponding lower energy and wear. When the quality of the feed begins to return to normal design quality at inflection 144, the VFD 50 increases rolls' rotational speed at inflection 146, returning towards to the design speed.

FIGS. 7A-8B are a few examples of how the variation of the speed of the crusher 12 speed on-the-fly can result in optimization of the crusher's rolls' 40,42 rotational speed n1,n2 in view of other operational parameters.

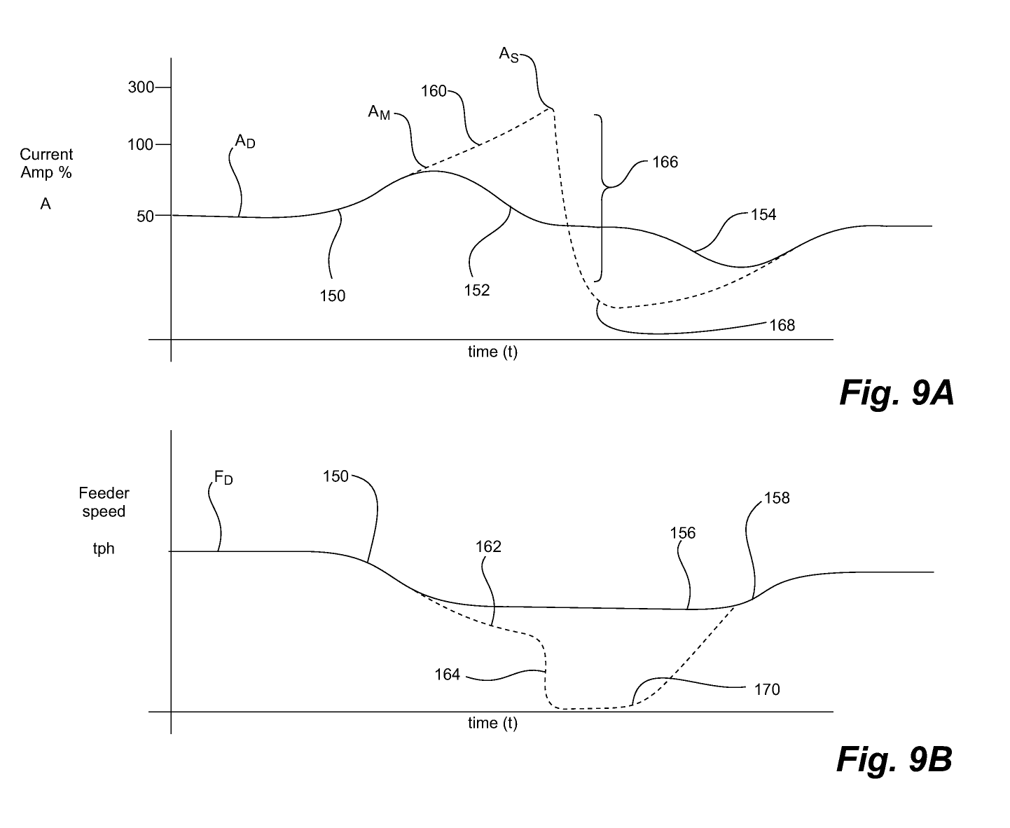

With reference to FIG. 9A and 9B, the rolls 40,42 and feeder 66 are controlled to maintain the processing of difficult feeds 80. Parameters related to difficult feed include a change in oil sand feed material consistency as the mine run varies including plasticity, for seasonal conditions, and for day to night temperature changes in material handling characteristics between heating and cooling cycles.

Difficult feed 80 is processed without shutdown, being maintained within operational maximum and minimum that can be handled by the equipment operating parameters. The figures, in corresponding dotted lines, feed 80 that exceeds operational parameters is managed and operation is resumed without shutdown of the double roll crusher 12.

In more detail, and with reference to the corresponding two solid line curves, the design motor current AD for crushing at the rolls might present at 50% of current A. The feeder speed is at some equivalent feed rate FD. The system controller 52 senses or otherwise identifies the magnitude of motor current A and a gradual rise at inflection or first transition 150 such as in response to difficult feed, the system controller correspondingly downwardly adjusting feed rate from the feeder. This coordinated behavior occurs as the rate of increase in motor current is below a first trigger rate and continuing up to and below a first current adjustment threshold AM. If the corrective action is successful, the motor current A diminishes at 152 and returns to about or through the design current AD. Further, if the motor current A continues to fall below the design motor current at AD, at 154, the feeder can remain at some slower than normal rate at 156, then the feeder rate can be increased once again at 158.

With reference to the two dotted line curves, and despite this corrective action at 150, the motor current A may continue to rise to a second transition 160 even while continuing to downwardly adjust the feed rate at 162 from the feeder 66. If the above VFD correction is not successful in arresting the rise in motor current, then, the system controller senses or otherwise detects continued motor current rise to a second threshold AS. As the motor current approaches or reaches the second threshold AS, the system control shuts off the feeder at 164.

As the feed is cleared from the rolls 40,42, the motor current A drops at 166, through the design current AD, to some partially loaded, idle level 168 and the feeder 66 is restarted at 170 to deliver oil sand feed 80 to the crusher 12 once again, the current at the motor increasing correspondingly as the load increases at the rolls.

Other examples of process control through implementation of the motor VFD 50 and related systems include hopper variables. Material difficulty aside, or in a stable condition, the hopper level may oscillates about an average setpoint, as the apron feeder control remains constant and the roll crusher speed R also remains generally constant. For discussion purposes, the average speed of the crusher rolls 40,42 remain about 50 rpm. However in the event that the hopper level drops below an alert level, the apron feeder control 64 will also begin to reduce the lineal speed of the feeder 66, removing oil sand feed material 80 from the hopper 60 at a lower rate. Correspondingly the rotational speed of the rolls can also be reduced preemptively say from 50 to 40 rpm, to receive the reducing amount of feed 80 while maintain or adjusting the performance parameters including one or more of optimal crushing efficiency, energy consumption and equipment wear. Further, if the hopper level continues to fall to a minimum threshold level, the apron feeder controller 64 or system control PLC 52 can be programmed to shut off and stop completely. Correspondingly the crusher speed can be reduced to zero or to an idle setting such as 20 rpm. Once the hopper level H is re-established, the apron feeder 66 resumes its operation at normal rates and the rotational speed of the rolls of the crusher 12 can be ramped up again to average or normal design operating speeds.

In another example, introduced in FIGS. 7A,7B the rotational speed of the crusher 12 can modulate between about 50 and 60 and maintain crushing of oil sand feed even as low as 45 rpm, corresponding to variations in the feed characteristics including particle distribution in the feed stream of oil sand. For example the proportion of the feed stream that is already less than 600 mm is nominally about 80% in normal mine operation, deemed the design feed. In other words, for a feed rate of 12,000 tph, then only 2,400 tph needs to be crushed to size, the balance already at, or less than, 600 mm in diameter. Should the finer particle percentage in the feed stream for ma greater proportion than anticipated say approaching 90%, being less work for the crusher (only 1,200 tph that need be crushed), then the VFD 50 or system PLC controller 52 then depending on process conditions, including surge capacity status, the controller can select from temporarily increasing the capacity of the crusher 12 by increasing the rotational speed of the rolls. Increased throughout is typically not an operational consideration except for replenishment of depleted surge or improved downstream plant capacity. As discussed above, increasing rotational speed is related to equipment life and more often process considerations are to reduce crusher speed for maintaining the design throughout at lesser work, and reduced wear. Further thereafter, should oversize increase, with the percentage of the particles less than 600 mm fall to about 70% of the feed stream, such as due to the inclusion of siltstone or other oversize material, then the crusher speed can be reduced correspondingly to compensate for the more difficult task of sizing the feed. Accordingly one can always adjust the roll speed for maximum production of fine material for any given capacity and material condition.

In a further example there is the possibility that hopper sensors 62 could detect a large piece of oversized such as a large rock, which is approaching the feeders discharge end 72. Accordingly using the sensors 62 and feedback from the apron feeder controller 64 the speed of the crusher 12 could be run at a higher rotational speed in anticipation of receiving a short term, yet instantaneous, load. Inertia of the rolls, and enhanced by flywheels 34,34, could store incremental energy needs to manage this short term load, without disruption of the process overall.

In yet another example of the advantage of operational flexibility through one-the-fly variable speed control, one can determine an optimum processing speed of the rolls for the purposes of reducing mechanical wear on the system by processing the desired capacity at a minimum rotational speed. As introduced above, generally, as roll speed is increased, throughput of sized oil and feed increases, as does component wear. Oil sand is known to have high erosive characteristics on moving surfaces. As the equipment is so massive, and correspondingly expensive, in many cases, parallel redundant crusher lines are not practical, and thus equipment failure or schedule maintenance interrupts the process flow, mitigated somewhat with material surge stations.

Other operational parameters include the empirical relationship of wear, double roll crusher speed and oils and feed character. As speed includes, and dependent on environmental effects on oil sand feed character, season and daily, for a given feed and character, above a increased speed there is a lessening in crushing efficiency. For such difficult materials, as oil sand feed, being intractable, compactable, plastic in cold conditions, and highly abrasive, the efficiency is impacted with materials, with the generally linear ratio wear rate with increasing roll speed shifts to even greater wear. The system controller 52 can establish the efficiency of the crusher processing capacity or throughput, compared to crusher maintenance and longevity. As stated, this relationship comparison or ratio is generally constant to a point at which the rolls are no longer able to process the material as effectively, resulting in diminished throughput increases with further roll speed increase. This efficiency relationship will be a function of the equipment maintenance life, in terms of mean time between failure (MTBF to breakdown, maintenance schedule, length of the maintenance turnaround and performance decrease as is compared to the design throughput of the crusher.

In embodiments, further complementary reductions in driveline length can be achieved due to a shorter lever arm and alignment issues, including the structure need to permit roll gap adjustment and impact dampening.

We claim:

1. A double roll crusher for mined oil sands feed of variable quality comprising:
contra-rotating double rolls in a parallel arrangement for forming a nip therebetween for receiving the oil sand feed, each roll having a driveline, each driveline comprising
a gearbox having input and output shafts, the output shafting being driveably connected to its respective roll;
an electric motor having a motor rotor driveably connected to the gearbox's input shaft;
a torque limiting coupling between the motor rotor and the gear box input shaft, the driveline having a rotating inertia; and
a variable frequency drive (VFD) having a variable frequency electrical output coupled to the motor of the respective driveline, wherein,
each VFD varies frequency and voltage to its respective motor for delivery of up to full load torque to the driveline and to vary the speed of the rolls commensurate with the quality of the oil sand feed.

2. The double roll crusher of claim 1 wherein upon startup of the double rolls, the VFD varies frequency and voltage for delivery of up to full load torque or and for a startup duration necessary to accelerate the driveline's rotating inertia and connected roll to operational rotational design speed of between about 40 rpm and about 60 rpm, the double rolls crushing the oil sand feed therebetween at a design throughput.

3. The oil sand crusher of claim 2 wherein the gear box has a 20:1 ratio and the motor has a speed range from 0 to 1200 rpm.

4. The double roll crusher of claim 1 wherein for a design throughput, the VFD determines a motor current and reduces the speed of the rolls as the motor current falls below a design motor current.

5. The double roll crusher of claim 1 wherein the oil sand feed comprises oil sand, and an oversize component, together having a feed quality, for a design throughout, the VFD determining the motor current and reducing the speed of the rolls as the motor current rises above a design motor current and increasing the speed of the rolls as the motor current falls below the design motor current.

6. An oil sand crushing system comprising the oil sand crusher of claim 1 and further comprising:
a hopper;
a feeder below the hopper and having a discharge positioned above the nip;
a feeder controller for varying the feed rate of oil sand feed from the feeder; and
a system controller connected to the double rolls VFDs and the feeder controller for adjusting feed rate from the feeder inverse proportional to the motor current at the VFD.

7. The oil sand crushing system of claim 6 wherein the system controller monitors motor current for:
a first transition in an increase in the motor current for downwardly adjusting feed rate from the feeder as the motor current rises, at a rate less than a trigger rate and up to a first adjustment threshold; and
a second transition in the increase in the motor current for shutting off the feeder as the motor current rises to a second shutdown threshold.

8. The oil sand crushing system of claim 7 wherein, after the feeder feed rate has been reduced and the motor current has fallen below the design current, controlling the feeder to increase the feed rate as the motor current rises towards the design motor current.

9. The oil sand crushing system of claim 6 wherein, the two VFDs are in electronic communication for synchronizing each driveline.

10. The oil sand crushing system of claim 6 wherein, the system controller synchronizes the VFD's for each driveline.

11. The oil sand crushing system of claim 6, wherein upon a stall in a forward crushing rotation, reducing the feed rate to zero, and activating the VFDs to reverse rotation of the motor rotors and vary frequency and voltage for delivery of full load torque to the rolls to clear the oil sand feed therefrom.

12. The oil sand crushing system of claim 11 wherein motor is controlled up to a predefined clearing speed while exploiting a predefined clearing load current, followed by a return to forwards power after having sensed a reversal of the drive shaft output for a predefined period of time or speed at the load current limit.

13. The oil sand crushing system of claim 11 wherein the rolls are reversed at least 90 degrees of rotation.

14. The oil sand crushing system of claim 11 after the system controller clears the oil sand feed in the rolls, activating the frequency inverter to resume normal forward crushing to accelerate the driveline's rotating inertia and double rolls to operational rotational design speed at the design throughput.

15. A method of controlling a double roll crusher for crushing mined oil sands feed having variable quality at a design throughput comprising:
receiving oil sand feed at the nip of contra-rotating double rolls, each roll having a driveline including an electric motor and a gear box connected to the respective roll; and
varying the voltage and frequency of the respective motor for delivery of up to full load torque to the driveline and to vary the speed of the rolls commensurate with the quality of the oil sand feed.

16. The method of claim 15, wherein the varying of the voltage and frequency of the motor is through a variable frequency drive (VFD), further comprising, upon startup of the double rolls, varying frequency and voltage of the motor for delivery of up to full load torque or and for a startup duration necessary to accelerate the driveline's rotating inertia and connected roll to the design rotational speed.

17. The method of claim 15, wherein for a design throughput,
determining a motor current that is falling below a design motor current, and
reducing the speed of the rolls, while maintaining a design throughput of oil sand feed through the rolls.

18. The method of claim 15, wherein the oil sand feed comprises oil sand, and an oversize component, together having a feed quality that varies over time;
determining a motor current for the current feed quality;
reducing the speed of the rolls as the motor current rises above a design motor current; and
increasing the speed of the rolls as the motor current falls below the design motor current.

19. The method of claim 15 further comprising:
determining a motor current;
controlling the rate of oil sand feed from a feeder and discharging into the rolls; and
adjusting feed rate discharging from the feeder inverse proportional to the motor current.
